(19) United States
(12) Patent Application Publication
(10) Pub. No.: US 2002/0121592 A1
(43) Pub. Date: Sep. 5, 2002

(54) Extended range frequency calibration device

(76) Inventor: Stephen F. Blazo, Mulino, OR (US)

Correspondence Address: STEPHEN BLAZO, 14711 S. BUCKNER CREEK ROAD, MULINO, OR, 97042, US

(21) Appl. No.: 09/798,381

(22) Filed: Mar. 5, 2001

(51) Int. Cl. G01J 5/08

(52) U.S. Cl. 250/227.11

(57) ABSTRACT

A calibration device consisting of a gas cell constructed so one window (16) is a Fabry-Perot etalon. The gas cell absorption lines are used to calibrate the Fabry-Perot etalon characteristics. Thus the device can be used to calibrate an optical instrument over a broad range of frequencies that are generated by the Fabry-Perot etalon with the accuracy determined by the stable gas absorption lines.

A gas cell in combination with other frequency artifact generators such a Fiber-Bragg grating (30). The artifact generator has artifacts both within the gas cell spectrum as well as beyond. The transmission characteristics within the gas cell spectrum are used to calibrate the artifact at frequencies outside this range.

### STATEMENT REGARDING FEDERALLY SPONSORED RESEARCH OR DEVELOPMENT

Not Applicable

### BACKGROUND OF THE INVENTION

This invention relates to a combination of an absorption cell with a means of generating broadband frequency artifacts to provide frequency reference calibration over a wider frequency range then that afforded by the gas cell alone.

Gas molecular absorption is used as a frequency reference for fiber optic communication systems. A typical use would be the calibration of optical spectrum analyzers or tunable lasers. The National Institute of Science and Technology offers two Standard Reference Materials, SRMs, for this purpose. These SRMs are cells that are fitted with fiber optic collimators and contain a tube filled with a gas that absorbs radiation in well defined lines that are very accurately known. Light from the input fiber is collimated into a beam, traverses the tube undergoing the wavelength selective absorption, and exits another collimator to be refocused into the output fiber. Two versions of the SRM are offered. One version, SRM 2517, uses a tube filled with carbon 12 acetylene gas and covers the frequency range from 198 Terahertz (1515 nm) to 194.7 Terahertz (1540 nm). The other version, SRM 2519 uses carbon 13 hydrogen cyanide and covers the frequency range from 195.9 Terahertz (1530 nm) to 191.9 Terahertz (1565 nm). These frequency references provide highly stable and accurate frequency standards in the frequency range that absorption lines exist.

These designs suffer from the limited range of frequency. This is limited by the basic properties of the gas used. The calibration cannot reliably be extended very far from an absorption line since the instrument scan cannot be guaranteed to be predictable very far from a calibration point. Gases that cover a wide frequency range especially in the range of interest in fiber optic communication are not available. For example the gases listed above only span the range from 1515 nm to 1565 nm in total. New windows of operation, such as the L-band from 1560 nm to 1620 nm, are of increasing interest in the industry. A means of providing a frequency reference that had the stability of a molecular absorption line over a wider frequency range would be of great interest.

Other means are used to provide frequency references over a broad frequency range. These include Fabry-Perot type filters sold by several vendors such as JDS Uniphase and Micron Optics as well as fiber Bragg gratings sold by many vendors. These solutions, while providing references over a broad frequency range, suffer from the fact that the accuracy of the frequency reference depends on environmental effects such as temperature and the absolute accuracy is subject to drift and other degradations over time.

### BRIEF SUMMARY OF THE INVENTION

Accordingly the present invention combines the use of a gas cell with its highly accurate but limited span calibration with a frequency artifact that has a broad frequency range. This combination may take several forms. In a preferred embodiment the gas cell itself is constructed with a Fabry-Perot etalon as one of the windows. In an alternate embodiment the gas cell is operated in series with a multi-line fiber Bragg grating. Several objects and advantages of the present invention are:

1. Provide a frequency reference that extends the frequency range beyond that provided by gas absorption lines alone.

1. Provide a means of having these extended frequency references exhibit the stability and absolute accuracy of the molecular absorption lines.

2. Provide a means where the molecular lines and the frequency artifact information is combined into one optical signal and the frequency artifact can be calibrated against the molecular lines.

### DESCRIPTION OF DRAWINGS

FIG. 1 is a cross section drawing of the preferred embodiment of an absorption cell including a Fabry-Perot etalon as one window

FIGS. 2a 2b and 2c are a series of graphs showing how the data from the device shown in FIG. 1 can be processed to achieve the wide wavelength range calibration.

FIG. 3 is a drawing of an alternate embodiment consisting of a fiber based absorption cell in series with a multi-line fiber Bragg grating.

FIG. 4 shows how the data from the device shown in FIG. 3 can be processed to provide the frequency reference information

### DETAILED DESCRIPTION OF THE INVENTION

A preferred embodiment of the present invention is shown in FIG. 1. A gas 12 with appropriate absorption lines is contained in an envelope 10. The envelope is provided with windows 14 and 16 to allow a beam of radiation to pass through. One window is coated with antireflection coatings 18 to minimize its effect on the transmission of the cell. The other window 16 is coated with layers 20 that provide for a partial reflection of the beam. The input beam 22 is a beam of radiation that is typically collimated. The output beam is typically directed to a photodiode detector or used as an input to an optical spectrum analyzer.

The beam of radiation 22 can be formed, for example, from the output of a tunable laser or might be from a broadband emitter or other source giving radiation in the frequency range of interest. The cell is filled with a gas that will exhibit absorption at certain frequencies determined by the energy level structure of the gas. For fiber optic communication in the 1550 nm band this gas is typically acetylene or hydrogen cyanide. The gas absorption lines do not typically cover the full range of frequencies of interest. In order to extend the frequency range of a calibration device the gas cell shown in FIG. 1 includes a low finesse Fabry-Perot etalon in series with the optical output as part of the cell itself. This etalon is formed by the application of partially reflective coatings 20 on both sides of window 16. This reflectance may come from the index of refraction mismatch at the window interface in which case no coating is necessary. Reflectance values from 3% to 20% are typically used. As is well known in the art this structure provides what is known as a Fabry-Perot etalon. The transmission of the window 20 will be nearly periodic in frequency with maximum and minimum transmission based on the theory of a Fabry-Perot etalon. For relatively low reflectance coatings the response is nearly sinisoidal. This quasi-periodic structure will continue over a broad frequency range. The period and phase of the Fabrey-Perot etalon response depends critically on the temperature and other environmental effects which are difficult to control. The addition of the gas cell absorption cascaded with the Fabry-Perot etalon allows the Fabry-Perot etalon model to be determined simultaneously and continuously during operation allowing for the high stability of the gas lines to be combined with the broad wavelength range of the etalon.

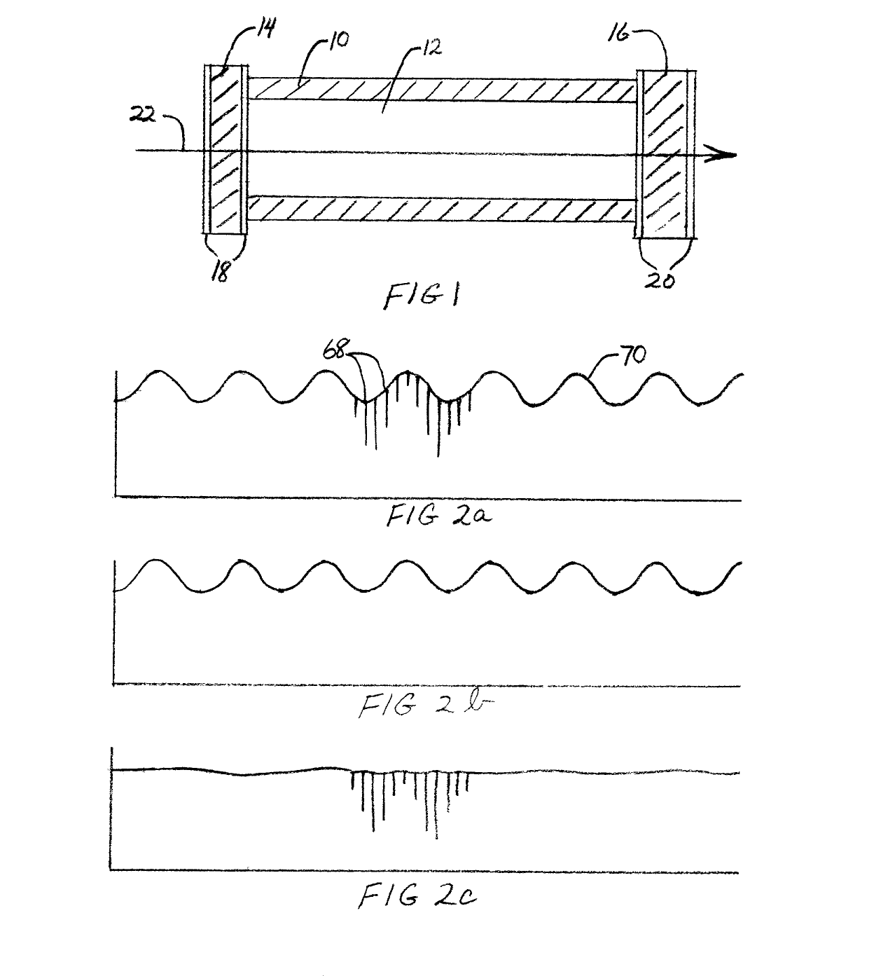

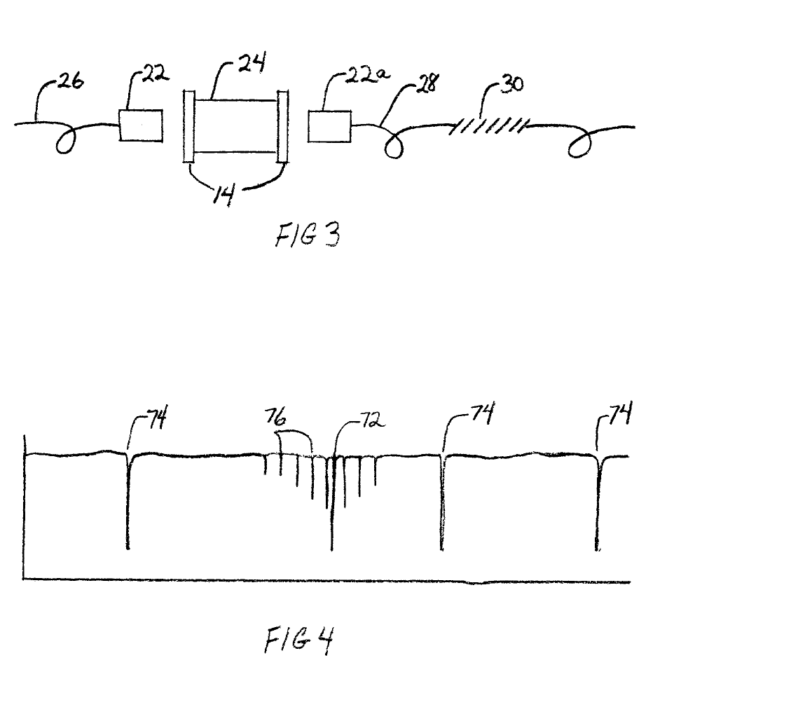

The operation of the device can be better understood by referring to FIG. 2a, 2b, and 2c. FIG. 2a represents the output of the preferred embodiment as a function of the input optical frequency. As can be seen the output is a product of the gas cell transmission which exhibits line absorption 68 over part of the frequency range and the nearly sinusoidal transmission 70 of the etalon. The gas lines are highly stable being based on fundamental physical constants. The etalon response will depend on details of the construction and will depend on temperature and other environmental effects. The information within the frequency range where there are gas lines present is used to develop a model for the transmission of the etalon that can be extended outside the range covered by the gas cells but still retains the inherent accuracy of the gas cell lines. For deep narrow absorption lines the raw spectra itself may be sufficient to develop a model for the transmission of the etalon. By standard digital processing algorithms the two effects can be separated to more easily analyze the overall effect. For example a narrow band filter which has a pass band at nearly the expected frequency of the etalon applied to the data will result in an output like FIG. 2b. Similarly a notch filter applied to the data will result in a waveform similar to FIG. 2c. The filtering will allow a very accurate model of the transmission characteristics of the device to be generated at other frequencies. The transmission model generated model will use the theory of the Fabry-Perot etalon and will normally also include effects due to dispersion of the window material.

An alternate embodiment is shown in FIG. 2. Here the input radiation is delivered by fiber 26 and collimated by collimating lens 22. The gas cell 24 has windows 14 that are antireflection coated so as not by themselves to influence the transmission of the cell. The output beam is focused back into fiber 28 by means of another collimating lens 22a. In series with the output fiber is a fiber Bragg grating 30. This grating has several lines written on it to selectively transmit the optical signal with selective gaps, similar in effect to a gas absorption line. One or more of these lines is fabricated so it will lie within the frequency range where the gas has absorption lines. Other lines are written so that they fall outside of the gas absorption lines and cover the frequency range of interest.

The operation of the alternate embodiment is similar to the preferred embodiment and can be best understood by referring to FIG. 4 which represents the transmission of the alternate embodiment as a function of input frequency. Some of Fiber Bragg grating lines 72 are written to fall within the range of the gas absorption lines and some 74 are written to fall over the rest of the frequency range. The exact position of the fiber Bragg grating lines will depend on temperature and other effects. The typical temperature effect might be 0.01 nm per degree centigrade. This effect will be very nearly the same for all the lines since they are all written on the same fiber. A comparison of the grating line position to the gas cell lines within the gas cell range will thus allow for a correction of the position of the remaining lines outside the gas cell range.

Other means of generating frequency artifacts may be used in place of the Fabry-Perot resonator and fiber Bragg grating discussed above. Many thin film structures and interferometer configurations may be used. The etalon may be cascaded with the gas cell without being an integral part of the cell itself. The only criteria is that the optical artifact exhibit an effect on the optical transmission that extends over a wide frequency rang and that the modeling and calibration of the transmission of the artifact over a narrow frequency range allows the extension of the calibration over a wide frequency range.

### CONCLUSIONS, RAMIFICATIONS, SCOPE

Accordingly the reader can see that the calibration device described allows for the high accuracy and stability of gas absorption to be extended in frequency range beyond that afforded by the gas cell lines themselves. This allows the use of a gas cell with a much stronger line characteristic but inferior coverage to satisfy a much wider range of application.

Although the description above contains many specificities, these should not be construed as limiting the scope of the invention but as merely providing illustrations of some of the presently preferred embodiments of the invention. The frequency artifact has been described as an etalon or as a fiber Bragg grating, but other devices such as Mach Zender or other interferometers or thin film filters can also be substituted.

I claim:

1. An apparatus for imposing on a source of radiation a frequency dependent intensity comprising:
A cell containing a gas exhibiting selective absorption over a portion of the frequency range and
A frequency artifact means that generates a frequency dependent pattern of intensity over a broad frequency range in series with the cell.

2. The apparatus of claim 1 where the frequency artifact is a Fabry-Perot etalon formed by one window of the absorption cell.

3. The apparatus of claim 1 where the frequency artifact is a thin film filter formed on one window of the gas cell.

4. The apparatus of claim 1 where the frequency artifact is a Fabry-Perot etalon cascaded with the gas cell.

5. The apparatus of claim 1 where the frequency artifact is a thin film filter cascaded with the gas cell.

6. The apparatus of claim 1 where the frequency artifact is a multiple line fiber Bragg grating cascaded with a fiber coupled gas cell.
